(19) United States
(12) Patent Application Publication
(10) Pub. No.: US 2002/0018471 A1
(43) Pub. Date: Feb. 14, 2002

(54) Method and system for voice-over-IP communication

(75) Inventor: Eran Shpak, Tel Aviv (IL)

Correspondence Address: DR. MARK FRIEDMAN LTD., c/o BILL POLKINGHORN, 9003 FLORIN WAY, UPPRMARLBORO, MD, 20772, US

(73) Assignee: LUCID V.O.N. LTD.

(21) Appl. No.: 09/923,419

(22) Filed: Aug. 8, 2001

Related U.S. Application Data
(60) Provisional application No. 60/223,991, filed on Aug. 9, 2000.

(51) Int. Cl. H04L 12/56

(52) U.S. Cl. 370/393; 370/473

(57) ABSTRACT

A method and system for transmitting voice communication from a plurality of end points, where the voice communication is packetized, to an access point. The end points and the access point are linked by a point-to-multipoint network, configured according to OSI layer 2, that includes a voice-over-IP gateway. The gateway negotiates end point aliases with the access point. The gateway then bundles the voice payloads of the packets received from the end points, along with the aliases, into a superpacket. The superpacket header includes a type field that indicates that the superpacket is not a prior art packet. The gateway then transmits the superpacket to the access point. The access point unbundles the superpacket for further transmission.

### FIELD AND BACKGROUND OF THE INVENTION

The present invention relates to voice-over-IP communication and, more particularly, to a method and system of point-to-multipoint voice-over-IP communication.

The Ethernet protocol is widely used in point-to-multipoint communication in local area networks (LANs). FIG. 1 shows a typical Ethernet packet 10. More specifically, packet 10 is a “RTP over Ethernet” packet. Packet 10 includes a header 12 followed by a payload 14. Header 12 includes 14 Ethernet header bytes followed by 40 IP/UDP/RTP bytes. The number of bytes in payload 14 is application dependent. For voice communication, payload 14 typically is a G.729 payload of 20 bytes. All the bytes of packet 10 are eight bits long

Packet 10 would be an inefficient vehicle for voice-over-IP in other point-to-multipoint systems, particularly in wireless systems, for two reasons. First, in wireless systems, bandwidth is at a premium. The high ratio of header bytes to payload bytes in packet 10 would make inefficient use the bandwidth of a wireless system. Second, at 74 bytes total length, packet 10 is relatively short. Voice-over-IP using packet 10 would entail transmitting a relatively large number of relatively short packets. Wireless systems are most efficient when a relatively small number of relatively long packets are transmitted.

There is thus a widely recognized need for, and it would be highly advantageous to have, a method of wireless voice-over-IP communication that makes more efficient use of the available bandwidth than presently known methods.

In point-to-point packet communication, for example, in data and voice communication over the Internet, it is common to increase the efficiency of the communication by header compression. Once a communication session is established, the portion of the packet header that will remain constant during the course of the session is replaced by a shorter (typically two bytes long) token. A transmitting party replaces the constant part of the header with the token, and the receiving party expands the token into the constant part of the header. It should be noted that header compression is not used in Ethernet LAN voice-over-IP.

### A NOTE ON NOMENCLATURE

Under the IEEE standard, the entities referred to herein as “packets” are called “frames”, and the entities referred to herein as “8-bit bytes” are called “octets”.

### SUMMARY OF THE INVENTION

According to the present invention there is provided a method of transmitting a plurality of voice communications from respective end points to an access point, including the steps of: (a) providing a point-to-multipoint network operative to send packets from the end points to the access point; (b) for each end point: (i) negotiating a respective alias with the access point, and (ii) configuring the respective voice communication as a voice payload; (c) concatenating a single superpacket header with the aliases and with the voice payloads to form a superpacket; and (d) sending the superpacket to the access point via the point-to-multipoint network.

Preferably the point-to-point network is configured according to OSI layer 2.

Preferably, the access point receives the superpacket and unbundles the superpacket into a plurality of received packets, with each received packet corresponding to a respective voice packet and with each received packet including a header configured according to the respective alias.

Preferably, the voice payloads are G.729 payloads.

Preferably, the superpacket header is an Ethernet header.

Preferably, the aliases and the voice packets are interleaved within the superpacket.

Preferably, the superpacket header includes a type field that indicates that the superpacket header is followed by the aliases and by the voice packets.

Preferably, each alias includes a respective station ID, and the negotiating of the aliases includes negotiating the respective station IDs.

Preferably, the voice packets are synchronized prior to being concatenated to form the superpacket.

Preferably, the negotiating and the concatenating are effected only by providing, in the point-to-multipoint network, a voice-over-IP gateway operative to effect the negotiating and the concatenating, and ten effecting the negotiating and the concatenating using the voice-over-IP gateway.

According to the present invention there is further provided a system for transmitting a plurality of voice packets from respective end points to an access point, including: (a) a voice-over-IP gateway for: (i) negotiating, with the access point, a respective alias for each end point, (ii) receiving, from each end point, a respective voice payload, and (iii) concatenating a single superpacket header with the aliases and with the voice payloads to form a superpacket; and (b) a mechanism for transmitting the superpacket to the access point.

Preferably, the mechanism includes either a wireless point-to-multipoint network or a cable TV point-to-multipoint network.

Preferably, the mechanism is configured according to OSI layer 2.

### BRIEF DESCRIPTION OF THE DRAWINGS

The invention is herein described, by way of example only, with reference to the accompanying drawings, wherein:

FIG. 1 (prior art) shows a RTP over Ethernet packet;

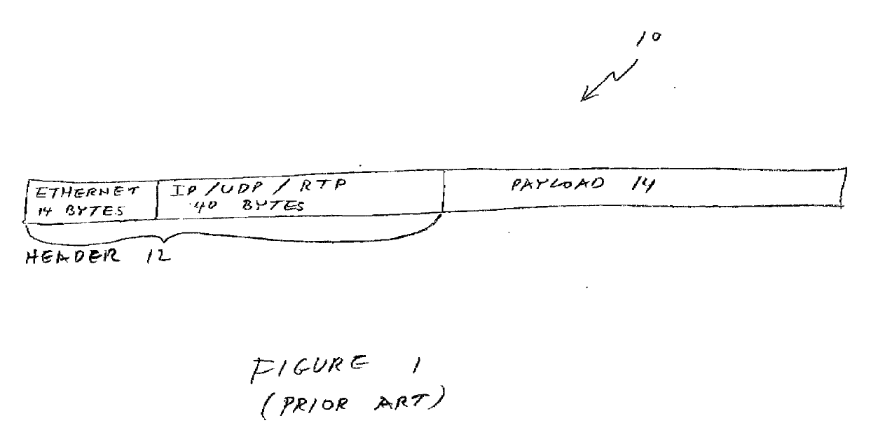

FIG. 2 shows a system of the present invention.

FIG. 3 shows a superpacket of the present invention.

### DESCRIPTION OF THE PREFERRED EMBODIMENTS

The present invention is of a method and system that can be used for efficient voice-over-IP communication over a wireless point to multipoint network. The present invention also is suitable for use in other point to multipoint networks, for example, cable TV networks.

The principles and operation of point-to-multipoint voice-over-IP according to the present invention may be better understood with reference to the drawings and the accompanying description.

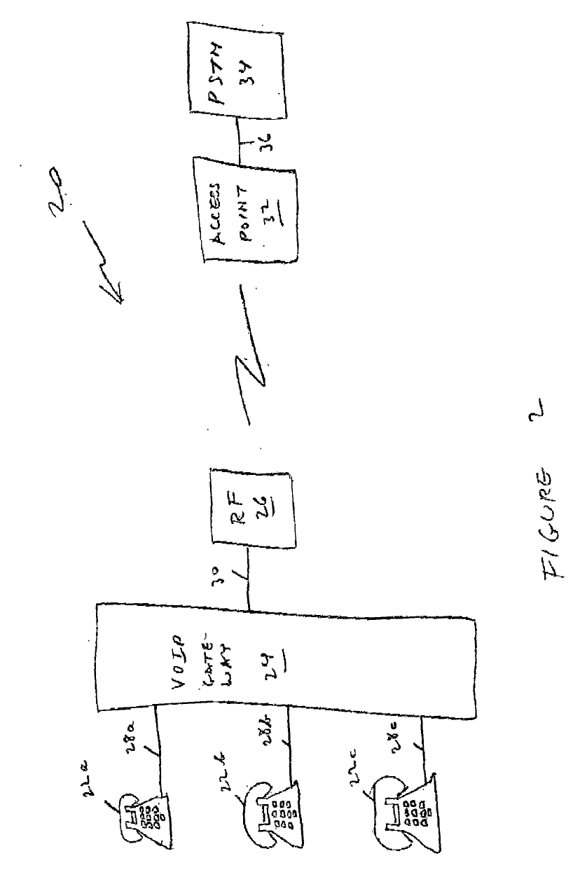

Referring again to the drawings, FIG. 2 illustrates a system 20 of the present invention. Three end points (IP telephones) 22 are connected by respective twisted wire pairs 28 to a voice-over IP gateway 24, which in turn is connected via a LAN 30 to a mechanism 26 that provides wireless RF communication to an access point 32. Access point 32 is in turn connected to a public switched telephone network (PSTN) 34 via a second LAN 36. In the absence of gateway 24, end points 22 would be connected directly to mechanism 26 via LAN 30, and system 20 would be a prior art point-to-multipoint network that exchanged voice-over-IP packets between end points 22 and PSTN 34 without header compression and packet bundling as described below. In particular, this prior art network would be configured according to OSI layer 2. Such networks also are referred to in the art as “OSI layer 2 bridges”, or equivalently as “MAC (medium access control) layer bridges”. A particular feature of the present invention is that gateway 24 can be inserted into a prior art OSI layer 2 bridge, as shown, with no other change to the existing infrastructure. In particular, no change needs to be made to the underlying OSI levels 1 (wireless PHY) and 2 (MAC) layers.

End points 22 transmit packets similar to packet 10 to gateway 24. In particular, the packets transmitted by end points 22 include G.729 voice payloads, each with 20 8-bit bytes. Gateway 24 performs header compression and bundling on these packets to create a “superpacket” that is transmitted to access point 32 via mechanism 26. The header compression performed by gateway 24 is similar to the header compression performed in prior art point-to-point voice-over-IP systems, except that because several end points 22 may be communicating with access point 32 simultaneously, each time a specific end point 22 establishes a communication session with access point 32, that end point 22 and access point 32 negotiate a unique 2-byte “circuit description” alias to use for that communication session. This circuit description alias includes a 6-bit station ID that identifies that specific end point 22.

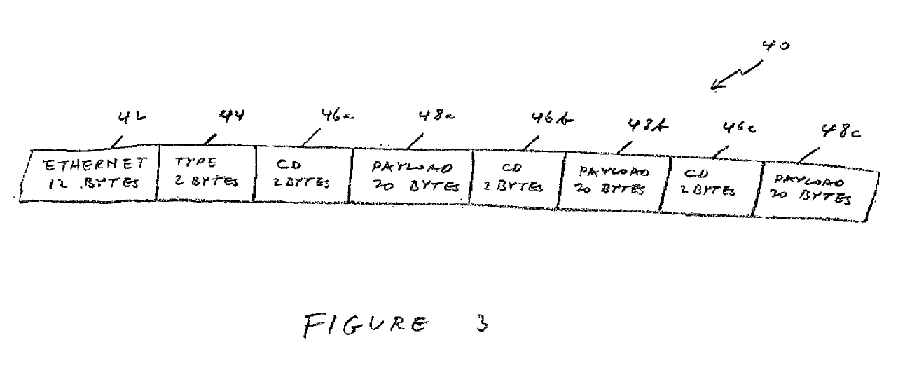

FIG. 3 shows a superpacket 40 created by gateway 24 for transmission to access point 32, in the course of three simultaneous communication sessions by end points 22 with access point 32. It is assumed that gateway 24 has received: from end point 22a, a respective voice-over-IP packet including a voice payload of 20 8-bit bytes; from end point 22b, a respective voice-over-IP packet including a voice payload of 20 8-bit bytes; and from end point 22c, a respective voice-over-IP packet including a voice payload of 20 8-bit bytes. Superpacket 40 includes 74 8-bit bytes in the following order: an Ethernet-like header field 42 of 12 bytes, a type field 44 of two bytes, a circuit description field 46a of two bytes, a payload field 48a of 20 bytes, a circuit description field 46b of two bytes, a payload field 48b of 20 bytes, a circuit description field 46c of two bytes and a payload field 48c of 20 bytes. Header field 42 and type field 44 together constitute the header of superpacket 40. Header field 42 is similar to the first 12 bytes of header 12. Type field 44 contains a preselected code that indicates to access point 34 that superpacket 40 is formatted according to the present invention. The inclusion of type field 44 in superpacket 40 allows the use of other preselected codes to indicate that superpacket 40 is formatted according to prior art formats, thereby enabling system 40 to transparently transmit either superpackets 40 of the present invention or prior art packets such as packet 10. Circuit description fields 46a, 46b and 46c contain, respectively, the circuit description aliases that have been negotiated between access point 32 and end points 22a, 22b and 22ec. Payload fields 48a, 48b and 48c contain, respectively, the voice payloads received from end points 22a, 22b and 22c.

Because the transmission of the separate packets from end points 22 to gateway 24 is not synchronized, gateway 24 also synchronizes the received packets before assembling superpacket 40.

Gateway 24 sends superpacket 40 to access point 32 via mechansim 26. By inspecting the contents of type field 44, access point 32 determines that the packet it has received is a superpacket 40 of the present invention. Access point 32 then unbundles superpacket 40 into three packets 10, with payload 14 of each packet 10 being the voice payload carried by a respective payload field 48a, 48b or 48c of superpacket 40 and with header 12 of each packet 10 being constructed in accordance with the contents of the respective circuit description field 46a, 46b or 41c. Access point 32 then sends the three packets 10 to PSTN 34 via LAN 36.

If the contents of type field 44 indicate that a received packet is a prior art packet rather than a superpacket 40 of the present invention, then gateway 24 sends the packet directly to PSTN 34 via LAN 36.

The presence of three circuit descriptor fields 46 and three payload fields 48 in superpacket 40 is only exemplary. Superpacket 40 can be configured with any convenient number of circuit descriptor fields 46 and associated payload fields 48.

As an example of the more efficient bandwidth use of the present invention, consider a system 20 configured according to the prior art (i.e., without gateway 24) and sending three packets 10 (one packet from each of end points 22) to PSTN 34 every 20 milliseconds (150 packets per second) via mechanism 26 and access point 32, hence with a link latency of 20 milliseconds. Each packet 10 is 74 8-bit bytes long, so the bandwidth per channel of mechanism 26 is 74*150*8/3=29,600 bps. Contrast this with system 20 configured according to the present invention with gateway 24 and sending one superpacket 40 every 20 milliseconds to access point 32 via mechanism 26. Superpacket 40 is 80 8-bit bytes long, so the bandwidth per channel of mechanism 26 is 80*50*8/3=10,667 bps,3 which is almost a threefold improvement over the prior art, with no increase in link latency.

While the invention has been described with respect to a limited number of embodiments, it will be appreciated that many variations, modifications and other applications of the invention may be made.

What is claimed is:

1. A method of transmitting a plurality of voice communications from respective end points to an access point, comprising the steps of:
(a) providing a point-to-multipoint network operative to send packets from the end points to the access point;
(b) for each end point:
(i) negotiating a respective alias with the access point, and
(ii) configuring the respective voice communication as a voice payload;
(c) conicatenating a single superpacket header with said aliases and with said voice payloads to form a superpacket; and
(d) sending said superpacket to the access point via said point-to-multipoint network.

2. The method of claim 1, wherein said point-to-multipoint network is configured according to OSI layer 2.

3. The method of claim 1, further comprising the step of:
(d) at the access point:
(i) receiving said superpacket; and
(ii) unbundling said superpacket into a plurality of received packets, each said received packet corresponding to a respective said voice packet, each said received packet including a header configured according to said respective alias.

4. The method of claim 1, wherein said voice payloads are G.729 payloads.

5. The method of claim 1, wherein said superpacket header is an Ethernet header.

6. The method of claim 1, wherein said aliases are interleaved with said voice packets in said superpacket.

7. The method of claim 1, wherein said superpacket header includes a type field that indicates that said superpacket header is followed by said aliases and by said voice packets.

8. The method of claim 1, wherein each said alias includes a respective station ID, and wherein, for each end point, said negotiating of said respective alias includes negotiating said respective station ID.

9. The method of claim 1, further comprising the step of:
(e) synchronizing said voice packets, prior to said concatenating.

10. The method of claim 1, wherein said negotiating and said concatenating are effected only by providing, in said point-to-multipoint network, a voice-over-IP gateway operative to effect said negotiating and said concatenating, and then effecting said negotiating and said concatenating using said voice-over-LP gateway.

11. A system for transmitting a plurality of voice packets from respective end points to an access point, comprising:
(a) a voice-over-IP gateway for:
(i) negotiating, with the access point, a respective alias for each end point,
(ii) receiving, from each end point, a respective voice payload, and
(iii) concatenating a single superpacket header with said aliases and with said voice payloads to form a superpacket; and
(b) a mechanism for transmitting said superpacket to the access point.

12. The system of claim 11, wherein said mechanism includes a wireless point-to-multipoint network.

13. The system of claim 11, wherein said mechanism includes a cable TV point-to-multipoint network.

14. The system of claim 11, wherein said mechanism is configured according to OSI layer 2.
